(19) United States
(12) Patent Application Publication
(10) Pub. No.: US 2015/0220184 A1
(43) Pub. Date: Aug. 6, 2015

(54) TOUCH SENSOR

(71) Applicant: SAMSUNG ELECTRO-MECHANICS CO., LTD., Gyeonggi-Do (KR)

(72) Inventors: Jang Ho PARK, Gyeonggi-Do (KR); Beom Seok OH, Gyeonggi-Do (KR); Tae Kyung LEE, Gyeonggi-Do (KR)

(73) Assignee: SAMSUNG ELECTRO-MECHANICS CO., LTD., Gyeonggi-Do (KR)

(21) Appl. No.: 14/267,655

(22) Filed: May 1, 2014

(30) Foreign Application Priority Data
Feb. 3, 2014 (KR) 10-2014-0012191

(51) Int. Cl. G06F 3/041; H01Q 1/22; G06F 3/044

(52) U.S. Cl. CPC G06F 3/0412; G06F 3/044; H01Q 1/22

(57) ABSTRACT

Embodiments of the invention provide a touch sensor, including a window substrate including a central region and an edge region formed to enclose the central region, a bezel part formed in the edge region on a rear of the window substrate and including at least one bezel layer, an antenna pattern formed in the bezel part and transmitted or received to or from the outside by wireless communication, and a sensor module including an electrode pattern, which is formed on a base substrate and corresponds to the central region and formed on a plane different from the antenna pattern.

### CROSS REFERENCE TO RELATED APPLICATION

This application claims the benefit of and priority under 35 U.S.C. §119 to Korean Patent Application No. KR 10-2014-0012191, entitled “Touch Sensor,” filed on Feb. 3, 2014, which is hereby incorporated by reference in its entirety into this application.

### BACKGROUND

1. Field of the Invention

The present invention to a touch sensor.

2. Description of the Related Art

With the development of computers using a digital technology, computer-aided devices have also been developed, and personal computers, portable transmitters and other personal information processors execute processing of texts and graphics using a variety of input devices such as a keyboard and a mouse.

However, a technology of the input device has been developing to satisfy, for example, high reliability, durability, innovativeness, design, processing related technologies, as well as satisfy general functions. To achieve the purposes, a capacitive touch panel has been developed as the input devices to input information, such as text and graphic, as described for example, in Korean Patent Publication No. 10-2013-0013350.

In addition, the touch panel is classified into a resistive touch panel, a capacitive touch panel, an electromagnetic touch panel, a surface acoustic wave (SAW) type touch panel, and an infrared touch panel. Among, those, a capacitive touch panel 100 is adapted for electronic products in consideration of a signal amplification problem, a resolution difference, a level of difficulty of designing and processing technologies, optical characteristics, electrical characteristics, mechanical characteristics, resistance to an environment characteristics, input characteristics, durability, and economic efficiency. Currently, the resistive touch panel and the capacitive touch panel have been prominently used in a wide range of fields.

Recently, with the development of smart devices, the touch panel is applied to almost all electronic devices, such as a mobile phone, a tablet, an ultra PC, a monitor, and a home appliance including TV. With the development of a technology and the increasing competition, the touch panel applied to these devices has been manufactured to have high-specification performance and a thinner thickness and save costs so as to meet a market demand.

Further, as various communication services with external or other mobile devices are increased and a data truffle transmitted or received is increased, a necessity of an antenna which may cover more frequency bands has been increased. In particular, for local wireless communication such as near field communication (NFC), a large antenna, and the like which may receive a signal in a low frequency hand has been required.

Therefore, antennas suitable for frequencies of various communication services are individually installed at various locations within a limited space range of the mobile device, such that an electrical interference with electronic components around the antennas and the accompanying communication frequency distortion, and the like may occur and transmission and reception sensitivity of antenna communication may be changed depending on a position of a user's hand.

### SUMMARY

Accordingly, embodiments of the invention provide a touch sensor capable of securing a mounting space of various antenna patterns depending on a frequency band by forming the antenna patterns for wireless communication in a bezel part on a window substrate.

According to an embodiment of the invention, there is provided a touch sensor including a window substrate including a central region and an edge region formed to enclose the central region, a bezel part formed in the edge region on a rear of the window substrate and including at least one bezel layer, an antenna pattern formed in the bezel part and transmitted or received to or from the outside by wireless communication, and a sensor including an electrode pattern, which is formed on a base substrate and corresponds to the central region and formed on a plane different from the antenna pattern.

According to an embodiment, the bezel part includes one bezel layer and the antenna pattern is formed on the bezel layer.

According to an embodiment, the bezel part includes a plurality of bezel layers and the antenna pattern is formed between the bezel layers.

According to an embodiment, the bezel part includes a plurality of bezel layers and the antenna pattern is formed on the bezel part.

According to an embodiment, the touch sensor further includes an anti-scattering film having one surface bonded to the rear of the window substrate and the other surface provided with the bezel part formed in a region corresponding to the edge region.

According to an embodiment, the bezel part includes one bezel layer and the antenna pattern may be formed on the bezel layer.

According to an embodiment, the bezel part includes a plurality of bezel layers and the antenna pattern is formed between the bezel layers.

According to an embodiment, the bezel part includes a plurality of bezel layers and the antenna pattern is formed on the bezel part.

According to an embodiment, the antenna pattern is formed only in a part of the region of the bezel part.

According to an embodiment, the sensor includes a first electrode pattern formed on one surface of the base substrate to be parallel with each other in one direction and a second electrode pattern formed on the other surface of the base substrate to be parallel with each other in a direction in which the second electrode pattern intersects the first electrode pattern.

According to an embodiment, the sensor includes a first electrode pattern formed on one surface of a first base substrate to be parallel with each other in one direction, and a second electrode pattern formed on one surface of a second base substrate to be parallel with each other in a direction in which the second electrode pattern intersects the first electrode pattern.

According to another embodiment of the invention, there is provided a touch sensor, including a window substrate including a central region and an edge region formed to enclose the central region, an electrode pattern formed in the central region on a rear of the window substrate, a bezel part formed in the edge region on a rear of the window substrate and including at least one bezel layer, and an antenna pattern formed in the bezel part and transmitted or received to or from the outside by wireless communication.

According to an embodiment, the bezel part includes one bezel layer and the antenna pattern is formed on the bezel layer.

According to an embodiment, the bezel part includes a plurality of bezel layers and the antenna pattern is formed between the bezel layers.

According to an embodiment, the antenna pattern is formed only in a part of the region of the bezel part.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a perspective view illustrating a display device including a touch sensor according to an embodiment of the invention.

FIG. 2 is a cross-sectional view of a touch screen according to an embodiment of the invention.

FIG. 3 is a cross-sectional view of a touch screen according to an embodiment of the invention.

FIG. 4 is a cross-sectional view of a touch screen according to an embodiment of the invention.

FIG. 5 is a plan view of the touch sensor according to an embodiment of the invention.

FIG. 6 is a cross-sectional view of a sensor according to an embodiment of the invention.

FIG. 7 is a cross-sectional view of a touch screen according to a fourth embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

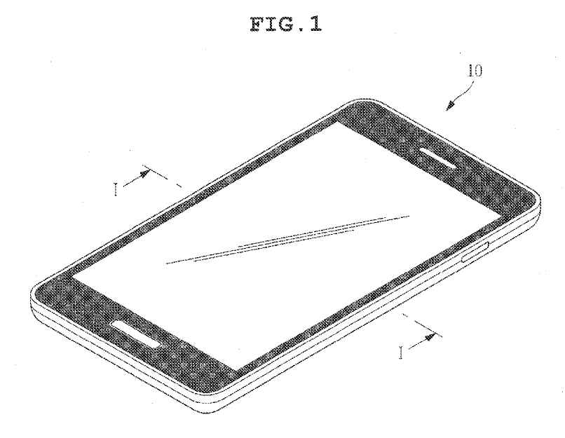

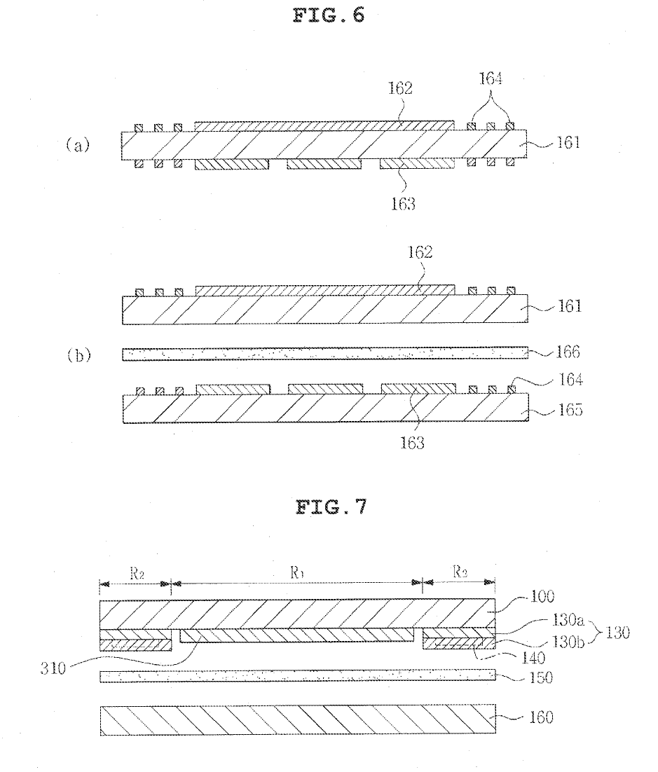

FIG. 1 is a perspective view illustrating a display device including a touch sensor according to an embodiment of the invention, FIGS. 2 to 4 are cross-sectional views of a touch sensor according to various embodiments of the invention taken along the line 1-1′ of FIG. 1, FIG. 5 is a plan view of the touch sensor according an embodiment of the invention, and FIG. 6 is a cross-sectional view of a sensor module according an embodiment of the invention.

A touch sensor 10 according to an embodiment of the invention includes a bezel part 130, which is formed in an edge region R2 on a rear of a window substrate 100, an antenna pattern 140, which is transmitted and received to or from the outside by wireless communication and is formed in the bezel part 130, electrode patterns 162 and 163, which are formed on base substrates 161 and 165, and a sensor unit 160, which is opposite to the window substrate 100 and is bonded to the bezel part 130. In this configuration, the touch sensor 10 includes a display unit 180, which is bonded to one surface of the touch sensor 10 and further includes an anti-scattering film 120, which has one surface bonded to the rear of the window substrate 100 and has the bezel part 130 formed in the region corresponding to the edge region R2.

According to an embodiment, the window substrate 100 includes a central region R1 and the edge region R2, which is formed to enclose the central region R1 and is disposed at an outermost side of the touch sensor 10 to be able to serve to receive a touch of a user and is made, for example, of tempered glass to be able to serve as a protective layer.

Further, as illustrated in FIG. 7, since a bezel part 130 and an electrode pattern 310 are formed on the rear of the window substrate 100, the rear of the window substrate 100 is subjected, for example, to high frequency treatment or primer treatment to improve an adhesion between the window substrate 100 and the bezel part 130 or the electrode pattern 310, thereby forming a surface treatment layer (not illustrated).

As illustrated in FIGS. 2 to 4, the bezel part 130, according to an embodiment, is formed in the edge region R2 on the rear of the window substrate 100 and includes at least one bezel layer 130a and 130b and serves to cover a region in which electrode wirings 164 having an opaque metal color on the base substrates 161 and 165 are formed, for example, with a decorative pattern, such as a maker logo.

According to an embodiment, the bezel part 130 is formed by sequentially stacking at least one bezel layers 130a and 130b, which is made, for example, of a black color, a white color, a green color, or a combination thereof, and a bezel composition including a silane, a colorant, and a binder resin, in which the bezel composition further includes, for example, a photo-polymerizable compound, a photo polymerizable initiator, or an additive.

Further, the bezel part 130, according to an embodiment, is formed in a region corresponding to the edge region R2 of the window substrate 100 on the anti-scattering film 120 and thus is formed, for example, in the edge region R2 on the rear of the window substrate 100 by bonding the anti-scattering film 120 to the window substrate 100.

Further, the antenna pattern 140 serves to transmit or receive a wireless signal related to near field communication (NFC), and a size and a shape of the antenna pattern 140 are determined, depending on the frequency band of the wireless signal. Therefore, according to the conventional art, since the antenna patterns 140 suitable for various wireless communication service frequencies are individually installed in various positions (e.g., a latter end, an outer region, etc, of a mobile device) within a limited space range of the mobile device, the mounting space of the antenna pattern 140 required for multi-functional wireless communication services may be limited and the accuracy of transmission and reception of wireless communications may be degraded due to electrical interference with other electronic parts (e.g., electrode patterns).

However, the antenna pattern 140 of the touch sensor 10 according to an embodiment of the invention is formed in the edge region R2 on the rear of the window substrate 100 and thus is formed in the bezel parts 130, 230, and 330, which serve to cover the region in which the electrode wirings 164 having the opaque metal color on the base substrates 161 and 165 are formed.

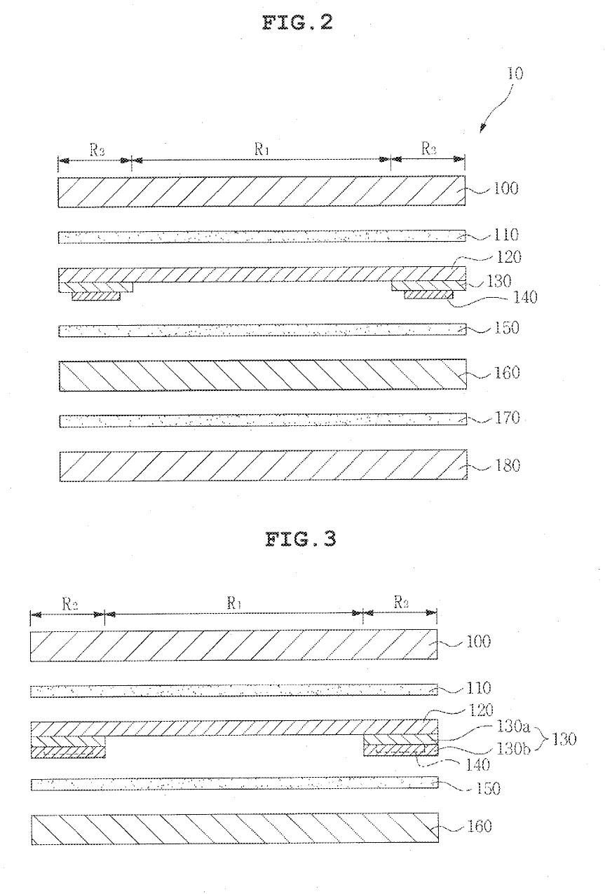

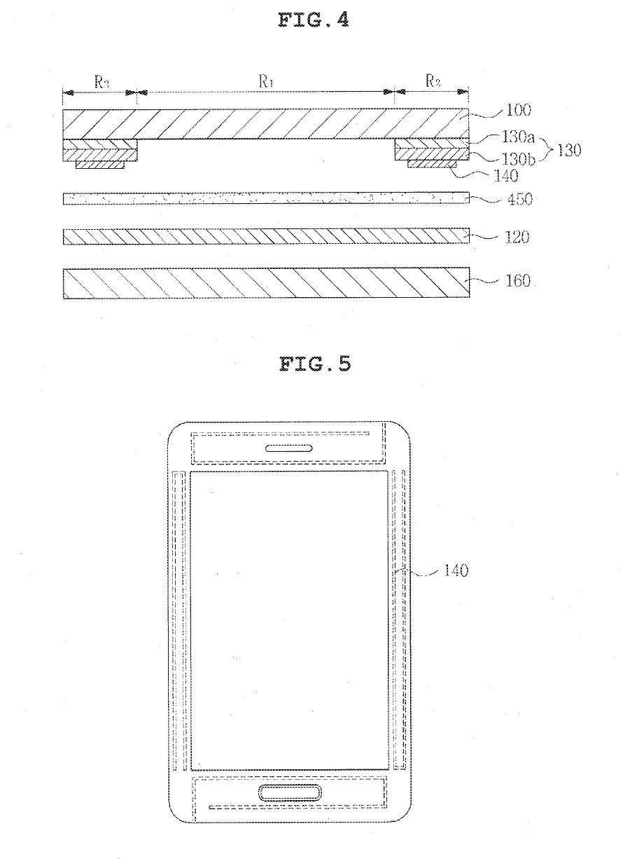

Thus, the bezel parts 130, 230, and 330 formed in the edge region R2 on the rear of the window substrate 100, according to various embodiments, include i) one bezel layer 130, in which the antenna pattern 140 is formed on the bezel layer 130 (see FIG. 2), ii) a plurality of bezel layers 230a and 230b or 330a and 330b, in which the antenna pattern 240 or 340 are formed between the bezel layers 230a and 230h or 330a and 330b (see FIG. 3 or 7), and iii) a plurality of bezel layers 430a and 430b, in which the antenna pattern 40 are formed on the bezel part 430 (see FIG. 4).

According to an embodiment, the bezel part 130 includes the plurality of bezel layers 130a and 130b and since the bezel layers 130a and 130b are sequentially stacked by a plurality of stacking processes and thus formed to have a thickness of 10 μm or more, the antenna pattern 140 is mounted between the bezel layers 130a and 130b and the antenna pattern 140 is made of metal having high conductivity, such as Ag, Cu, Al, and the like, and is formed in the whole or a part of the region of the bezel part 130 of the edge region R2 on the rear of the window substrate 100 by a screen printing method, an imprinting method, a photolithography method, as non-limiting examples (see FIG. 5).

According to various embodiments of the invention, it is possible to more effectively secure the space in Which the antenna patterns suitable for the signals in various frequency bands used in the multi-functional communication environments are mounted, as compared with the conventional art having a form in which the antenna patterns are mounted in the limited space range, due to the structure in which the antenna patterns for wireless communication are mounted in the bezel part formed in the edge region on the rear of the window substrate.

According to an embodiment, adhesive layers 110, 150, and 170 serve to bond components of the touch sensor 10 to each other and are made of a transparent material so as not to hinder a user from recognizing an image output through the display unit 180, for example, an optical clear adhesive (OCA).

According to an embodiment, the display unit 180, which is bonded to one surface of the touch sensor 10 through the adhesive layer 170 is a display device, which visually outputs data on a screen and includes, for example, a cathode ray tube (CRT), a liquid crystal display (LCD), a plasma display panel (PDP), a light emitting diode (LED), and an organic light emitting diode (OLED), but is not necessarily limited thereto.

As described above, it is not only possible to secure the mounting space of various antenna patterns and when the antenna pattern made of the conductive metal for wireless communication is formed between the bezel layers (see FIGS. 3 and 7), but also improve characteristics of anti-moisture of the antenna pattern 140 and secure the durability of the capacitive touch sensor, due to the structure in which the antenna patterns for wireless communication are mounted in the bezel part formed in the edge region on the rear of the window substrate.

As illustrated in FIG. 6, the sensor module 160 includes i) a first electrode pattern 162, which is formed on one surface of the base substrate 161 to be parallel with each other in one direction and a second electrode pattern 163, which is formed on the other surface of the base substrate 161 to be parallel with each other in a direction in which the second electrode pattern 163 intersects the first electrode pattern 162 (see FIG. 6A), ii) the first electrode pattern 162, which is formed on one surface of the base substrate 161 to be parallel with each other in one direction and the second electrode pattern 163, which is formed on one surface of the second base substrate 165 to be parallel with each other in a direction in which the second electrode pattern 163 intersects the first electrode pattern 162 (see FIG. 6B), and iii) the electrode wirings 164, which are electrically connected to ends of the first and second electrode patterns 162 and 163.

Thus, the antenna pattern 140, according to an embodiment of the invention, is mounted in the bezel part 130 of the edge region R2 on the rear of the window substrate 100 provided on a plane different from the base substrates 161 and 165, and thus is provided to be spaced apart from the first electrode pattern 162, the second electrode pattern 163, and the electrode wiring 164, which are formed on the base substrates 161 and 165 and made of a conductive material.

As described above, the antenna pattern in the touch sensor according to an embodiment of the invention minimizes the mutual electrical interference, which may be caused due to the antenna patterns and the electrode patterns made of the conductive material, which are formed on the same plane and secure the reliability of transmission and reception of the frequency signal in various communication environments, by the structure in winch the antenna patterns for wireless communication are mounted in the bezel part of the edge region on the rear of the window substrate provided on the plane different from the base substrate.

According to various embodiments of the invention, it is possible to secure the space in which the antenna patterns suitable for the signals in various frequency bands used in more various communication environments may be effectively mounted, due to the structure in which the antenna patterns for wireless communication are mounted in the bezel part formed in the edge region on the rear of the window substrate.

In-addition, it is possible to minimize the mutual electrical interference, which may be caused due to the antenna patterns and the electrode patterns made of the conductive material, which are formed on the same plane and secure the reliability of transmission and reception of the frequency signal in various communication environments by mounting the antenna patterns for wireless communication in the bezel part of the edge region on the rear of the window substrate provided on the plane different from the base substrate.

In addition, it is possible to improve the characteristics of anti-moisture of the antenna patterns and secure the durability of the capacitive touch sensor by forming the bezel part configured of the plurality of bezel layers on the rear of the window substrate and forming the antenna patterns made of the conductive metal for wireless communication between the bezel layers.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having, meanings and concepts relevant to the technical scope of the present invention based on the rule according to which an inventor can appropriately define the concept of the term to describe the best method he or she knows for carrying out the invention.

The terms “first,” “second”, “third,” “fourth,” and the like, in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and Certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning, that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein, do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A touch sensor, comprising:
a window substrate comprising a central region and an edge region formed to enclose the central region;
a bezel part formed in the edge region on a rear of the window substrate and comprising at least one bezel layer;
an antenna pattern formed in the bezel part and transmitted or received to or from the outside by wireless communication; and
a sensor module comprising an electrode pattern which is formed on a base substrate and corresponds to the central region and formed on a plane different from the antenna pattern.

2. The touch sensor as set forth in claim 1, wherein the bezel part comprises one bezel layer and the antenna pattern is formed on the bezel layer.

3. The touch sensor as set forth in claim 1, wherein the bezel part comprises a plurality of bezel layers and the antenna pattern is formed between the bezel layers.

4. The touch sensor as set forth in claim 1, wherein the bezel part comprises a plurality of bezel layers and the antenna pattern is formed on the bezel part.

5. The touch sensor as set forth in claim 1, further comprising:
an anti-scattering film having one surface bonded to the rear of the window substrate and the other surface provided with the bezel part formed in a region corresponding to the edge region.

6. The touch sensor as set forth in claim 5, wherein the bezel part comprises one bezel layer and the antenna pattern is formed on the bezel layer.

7. The touch sensor as set forth in claim 5, wherein the bezel part comprises a plurality of bezel layers and the antenna pattern is formed between the bezel layers.

8. The touch sensor as set forth in claim 5, wherein the bezel part comprises a plurality of bezel layers and the antenna pattern is formed on the bezel part.

9. The touch sensor as set forth in claim 1, wherein the antenna pattern is formed only in a part of the region of the bezel part.

10. The touch sensor as set forth in claim 1, wherein the sensor module comprises:
a first electrode pattern formed on one surface of the base substrate to be parallel with each other in one direction; and
a second electrode pattern formed on the other surface of the base substrate to be parallel with each other in a direction in which the second electrode pattern intersects the first electrode pattern.

11. The touch sensor as set forth in claim 1, wherein the sensor module comprises:
a first electrode pattern formed on one surface of a first base substrate to be parallel with each other in one direction; and
a second electrode pattern formed on one surface of a second base substrate to be parallel with each other in a direction in which the second electrode pattern intersects the first electrode pattern.

12. A touch sensor, comprising:
a window substrate comprising a central region and an edge region formed to enclose the central region;
an electrode pattern formed in the central region on a rear of the window substrate;
a bezel part formed in the edge region on a rear of the window substrate and comprising at least one bezel layer; and
an antenna pattern formed in the bezel part and transmitted or received to or from the outside by wireless communication.

13. The touch sensor as set forth in claim 12, wherein the bezel part comprises one bezel layer and the antenna pattern is formed on the bezel layer.

14. The touch sensor as set forth in claim 12, wherein the bezel part comprises a plurality of bezel layers and the antenna pattern is formed between the bezel layers.

15. The touch sensor as set forth in claim 12, wherein the antenna pattern is formed only in a part of the region of the bezel part.
